(19) United States
(12) Patent Application Publication
(10) Pub. No.: US 2017/0078713 A1
(43) Pub. Date: Mar. 16, 2017

(54) Cloud Image Renderer

(71) Applicant: Cisco Technology, Inc., San Jose, CA (US)

(72) Inventors: Meidad Zaharia, Rishon Le Zion (IL); Lalit Kataria, Johns Creek, GA (US); David William Fink, Efrat (IL); Simon Lomas, Winchester (GB); Enrique Gerstl, Maale Michmash (IL); Reuven Nimrod, Mevasseret Zion (IL); Roie Kerstein, Jerusalem (IL); Miles Colin John Davis, Twickenham (GB); Fabien Locquet, Sevres (FR)

(21) Appl. No.: 15/194,895

(22) Filed: Jun. 28, 2016

Related U.S. Application Data
(60) Provisional application No. 62/216,415, filed on Sep. 10, 2015.

(51) Int. Cl. H04N 21/231; H04L 29/08

(52) U.S. Cl. CPC H04N 21/23106; H04L 67/10

(57) ABSTRACT

Cloud image rendering may be provided. First, a first request for a multi-layered image may be received. Then, the requested multi-layered image may be rendered on a cloud computing system. The rendered multi-layered image may then be sent to a first requestor corresponding to the first request. Next, the rendered multi-layered image may be cached on a cache located on the cloud computing system. A second request for the multi-layered image may then be received. In response, the rendered multi-layered image may be sent to a second requestor corresponding to the second request from the cache located on the cloud computing system.

### RELATED APPLICATION

Under provisions of 35 U.S.C. §119(e), Applicants claim the benefit of U.S. provisional application No. 62/216,415, filed Sep. 10, 2015, which is incorporated herein by reference.

### TECHNICAL FIELD

The present disclosure relates generally to cloud television.

### BACKGROUND

Cloud computing is a model that allows access to a shared pool of configurable computing resources. Cloud computing and storage solutions provide users and enterprises with various capabilities to store and process their data in third-party data centers. It shares resources to achieve coherence and economies of scale.

Cloud computing also focuses on maximizing the effectiveness of the shared resources. Cloud resources are usually not only shared by multiple users, but are also dynamically reallocated per demand. This can work for allocating resources to users. For example, a cloud computer facility that serves European users during European business hours with a specific application (e.g., e-mail) may reallocate the same resources to serve North American users during North American business hours with a different application (e.g., a web server). This approach helps maximize computing power use while reducing the overall resources cost by using, for example, less power, air conditioning, rack space, to maintain the system. With cloud computing, multiple users can access a single server to retrieve and update their data without purchasing licenses for different applications.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of a cloud television application platform (CTAP);

FIG. 2 shows a multi-layered image;

FIG. 3 is a flow chart of a method for providing cloud image rendering;

FIG. 4 is a flow chart of a method for providing cloud image rendering;

FIG. 5 is a block diagram of a CTAP utilizing an image renderer; and

FIG. 6 is a block diagram of a computing device.

### DETAILED DESCRIPTION

### Overview

Cloud image rendering may be provided. First, a first request for a multi-layered image may be received. Then, the requested multi-layered image may be rendered on a cloud computing system. The rendered multi-layered image may then be sent to a first requestor corresponding to the first request. Next, the rendered multi-layered image may be cached on a cache located on the cloud computing system. A second request for the multi-layered image may then be received. In response, the rendered multi-layered image may be sent to a second requestor corresponding to the second request from the cache located on the cloud computing system.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Video operators competing in the marketplace today may be presented with a challenging set of demands. They may require a high service velocity enabling them to deploy new features and user experiences rapidly and with confidence. They may want to be able to roll these features out across the population in a flexible fashion. In addition, they may need analytics to measure the effectiveness of each new feature which is deployed. Furthermore, they may seek to bring their product and user experience to a wide range of consumer device types; high-end set-top boxes (STBs), secondary multi-room zappers, OTT zappers, smart TVs, smart phones, tablets, PCs, and game consoles.

Many operators may be long term incumbents and may need to unify increasingly siloed brown field systems together to evolve their platforms into a competitive converged offering over these different consumer devices. Increasingly larger operators may be looking for operational economies of scale across multi-country franchise foot prints. Top tier operators may look for the operational surety they perceive with and material ownership of physical platform resources, while smaller operators are looking for the opportunity to consume commodity compute resources as they grow new services. Larger operators may look to differentiate themselves with user interface (UI) design and platform features and may be looking to bring their own user experience, while smaller operators may be looking to leverage product oriented user experience (UX). Moving TV application execution onto a common cloud scaled platform may hold the key to dealing with these challenges. These problems may be solved by a flexible TV application execution platform that can run EPG behavior in the cloud, provide a foundational range of editorially customizable user experience, and support rapid shaped feature extensibility, with well delineated scope for customizations.

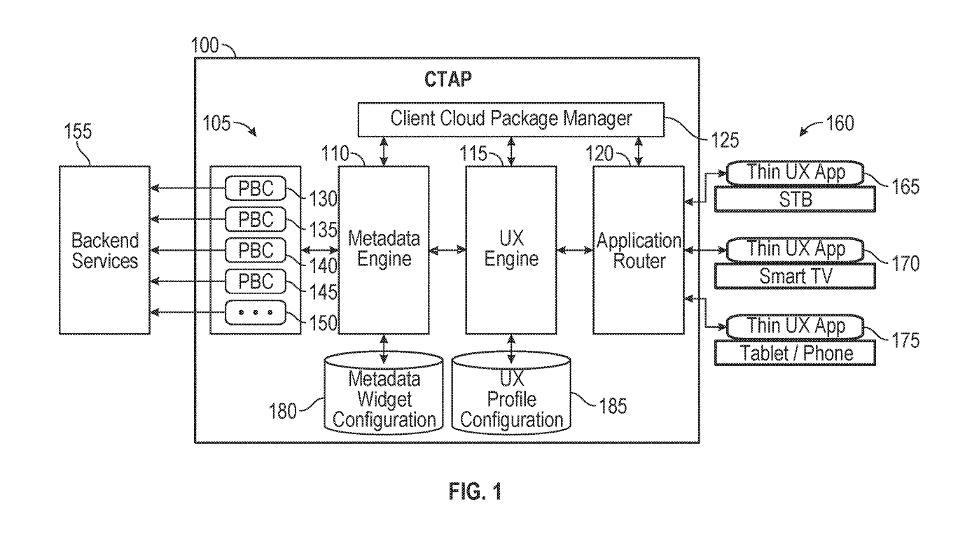

As shown in FIG. 1, a cloud television application platform (CTAP) 100 may be provided by embodiments of the disclosure. CTAP 100 may comprise a cloud computing device that may comprise a cloud scaled television (TV) application execution platform, supporting rapid declarative definition of user experience (UX) application behavior via an extensible library of TV metadata abstractions to operate over a heterogeneous client base. Flexible backend service integration via connector plugins may allow TV applications developed to quickly blend and extend data from disparate sources without impact to the core platform. Application feature behavior may be targeted at a device level of granularity providing for shaped A/B feature deployment at a high service velocity. CTAP 100 may lead to a simpler cloud and client application. Thinner client applications may lead to better gearing and performance against the cloud. This may be important for embedded STB platforms.

In other words, CTAP 100 may provide a significant drop in complexity/bugs with fewer lines of executable code in the application. In addition, CTAP 100 may provide a low client resource utilization (e.g., CPU cycles, memory) and improved overall performance. Easier portability may also be provided by CTAP 100 driving towards a homogeneous TV application used over a heterogeneous client device base. Cloud infrastructure may be better leveraged and more scalable by offloading more processing to the cloud enhancing scalability, robustness, and performance. Furthermore, being backend agnostic, CTAP 100 may be flexible and may connect to any given backend. Multiple devices and multiple tenancies may be supported.

As shown in FIG. 1, CTAP 100 may comprise several sub-system layers that may be flexibly deployed on cloud computer resources to interface with thin user experience applications resident on users devices (tablets, smart phones, computers, televisions, etc.). For example, CTAP 100 may comprise a plurality of pluggable backend connectors (PBCs) 105, a metadata engine 110, a user experience (UX) engine 115, an application router 120, and a client cloud package manager (CCPM) 125. Plurality of pluggable backend connectors (PBCs) 105 may comprise a first PBC 130, a second PBC 135, a third PCB 140, a forth PCB 145, and an n^{th} PCB 150.

PBCs 105 of CTAP 100 may respectively connect to a plurality of backend services 155 over a network, for example, the internet. Plurality of backend services 155 may comprise a set of control and data plane services that may provide underlying capabilities of CTAP 100. Plurality of backend services 155 may come from a range of vendors and provide disparate proprietary interfaces that provide access to the services. Plurality of backend services 155 may comprise, but are not limited to, identity management, content management, offer management, catalogue management, content protection, session management, and a recommendation engine. Identity management may comprise end user account, entitlement, and device identifying information. Content management may comprise curation, publication, and management of on demand content. Offer management may comprise definition and management of retail products sold through the platform to end users. Catalogue management may comprise published content descriptive metadata, channel lineups, and on-demand content navigation hierarchies. Content protection may comprise realtime content encryption and license generation services. Session management may comprise realtime, policy based allocation of on-demand and linear video sessions. And the recommendation engine may comprise generation of end user facing content recommendations based on viewer preferences.

Furthermore, in the growing TV ecosystem, plurality of backend services 155 may be extending to include platform external services that contribute to the user experience. This extended group may comprise, but is not limited to, social media systems (e.g., Facebook, Twitter, etc.) and enriched metadata sources (e.g., Imdb, rotten tomatoes, etc.).

Each of plurality of PBCs 105 may provide an encapsulated backend service integration point with corresponding ones of backend service 155 that may allow CTAP 100 to be backend agnostic. Plurality of PBCs 105 may include a library of canonical APIs that describe TV resources (e.g., channel, asset, account, recommendation, etc.). Each resource can be considered as available form a range of ‘sources’—an asset may be on-demand, linear, or on a PVR, etc. To support integration to a given back service, plurality of PBCs 105 may be defined for each resource type and source needed for a TV application (e.g., on demand asset, PVR asset, linear asset (event)). Each of the plurality of PBCs 105 may be implemented to fulfil the canonical API contract for the defined TV resource. Each of the plurality of PBCs 105 may fully encapsulate the knowledge of how to retrieve the resource data from a given source from a backend service. In addition, each of the plurality of PBCs 105 may be deployed, scaled, and managed with an independent lifecycle. Plurality of PBCs 105 may provide the metadata engine with access to the canonical resources needed to form TV metadata aggregations (see below). The implementation of plurality of PBCs 105 may be UX agnostic and may be reused for many distinct UX definitions.

CTAP 100 may connect to a plurality of thin UX applications 160 over a network, for example, the internet. Plurality of thin UX applications 160 may comprise, but are not limited to a first thin UX application 165 (e.g., on a set top box), a second thin UX application 170 (e.g., on a smart TV), and a third thin UX application 175 (e.g., on a tablet computing device, a smart phone, etc.). Any of plurality of thin UX applications 160 may run on any type device. Each of plurality of thin UX applications 160 may comprise a minimal client resident UX application that may deliver the view layer of the TV application experience to an end user. Its behavior may be fully data driven from the cloud and may have no independent user interaction capability. In each cloud interaction, each of plurality of thin UX applications 160 may receive a full defined set of resources. The full defined set of resources may comprise text, images, graphical templates, textures, etc., to display to the end user. The full defined set of resources may further comprise personalized next step user interactions and how to report these back to CTAP 100. Each of plurality of thin UX applications 160 may interact with native device services for, content consumption functions, user input handling, device settings, and local GPU and rendering services when leveraged.

CCPM 125 may provide a registry of application metadata that describes resources that may be needed for CTAP 100 to generate a given user experience. Each entry in the registry may define client cloud package version (ccpVersion) properties including, but not limited to, UX API version, metadata widget configuration files 180, UX profile configuration files 185 that may drive CTAP 100's API response generation. Each ccpVersion stored may be keyed for tenant and device type. Each end-user facing device in the platform may be decorated with a ccpVersion that may be used by application router 120. Metadata engine 110 may provide a source agnostic TV metadata aggregation service for use by UX engine 115. It may also provide a library of defined TV aggregation tasks returning a canonical ‘metadata widget’ response resource to UX engine 115. Each aggregation task may define how to combine a nominated set of canonical response resources (e.g., combine personalized favorite channels and the operator defined regional channel map to define a channel list for ordered ‘zapping’). The PBCs to use for acquiring nominated canonical resources may be resolved dynamically. The aggregation tasks may be generic and may be reused by many different end user facing UXs. The aggregation task library may be extensible via code without perturbation to the existing tasks.

Population of the metadata widget by the aggregation task may be declaratively defined by a configuration file controlling, for example: i) which sources to collect metadata from (e.g., operator defined channel map, and personally defined favorite channels); ii) which PBCs to use for each source, and which set/subset parameters to fetch from the canonical PBC resource; and iii) how many canonical PBC resources to fetch, and how to sort and merge them. The metadata engine may interact with CCPM 125 to identify the appropriate set of metadata widget configurations to use for the nominated user experience (ccpVersion). Thus, each aggregation request may be shaped to the needs of a given user experience just in time.

UX engine 115 may host the API end-points leveraged during client/cloud communication, and may be responsible for final response formatting. Each API end-point may be fully resolving the metadata and resources to generate the user experience for a given UI ‘screen’. UX engine 115 may also include declarative ‘UX profile’ configurations that may define the detail of the response generation for a given API end-point. The response generation may include next page/screen navigation links that may be included to define the flow and navigation (e.g., page down to retrieve more assets, or click through to learn more about an individual asset). The response generation may also include contextual actions links that can be associated with a given resource (play, book, buy, etc.). In addition, the response generation may also include business logic rules that may define conditional behaviors for determining availability of contextual actions (e.g., apply pin control if after watershed before play).

UX engine 115 may collaborate with CCPM 125 to discover the declarative UX profile configuration files that may define the response generation procedure for the nominated UX version (ccpVersion). Driven by the declarative configuration files, UX engine 115 may generate the user experience for a given UI ‘screen’. In addition, UX engine 115 may invoke metadata engine 110 to carry out backend aggregation tasks identified. UX engine 115 may execute business logic to provide context appropriate navigational control to the application. In addition, UX engine 115 may execute cloud UX rendering services. Graphical resources (e.g., screen template, textures, etc.) that may be required by the nominated UX variant (ccpVersion) may be identified by the UX engine 115.

Moreover, the UX engine 115 may also utilizes a dynamic schema mapping technique to transform the resources gathered into the response format appropriate for the nominated UX variant. The distinct UX engine variants may be instantiated to support the needs of a given tenant, device type, UX type and version.

Application router 120 may collaborate with other cloud services to authenticate and identify the client device, and associated backend account constructs. Based on this information, application router 120 may collaborate with CCPM 125 to identify the user experience variant (ccpVersion) nominated for that device. Each request from plurality of thin UX applications 160 may then be directed to the appropriate UX engine based on the nominated UX variant. This may provide the first step in a layered series of A/B feature shaping flows. Application router 120 may also provide statistics around device connections (e.g., API calls, number of connection, load, etc.).

There are many problems in conventional layered/filtered imaging processing in a client device. For example, it may be hard to process layered/filtered images on low end STBs/devices. With conventional systems, deploying changes may be very complex and dynamic changes may not be possible if client software needs to be updated. Personalized graphics across a population may not be possible.

Embodiments of the disclosure may provide image rendering for multi-layered assets in the cloud with a cache mechanism to save CPU and performance in the client device. In addition, low end hardware devices or intensive CPU clients can benefit from the cloud capabilities to reduce local processing of images.

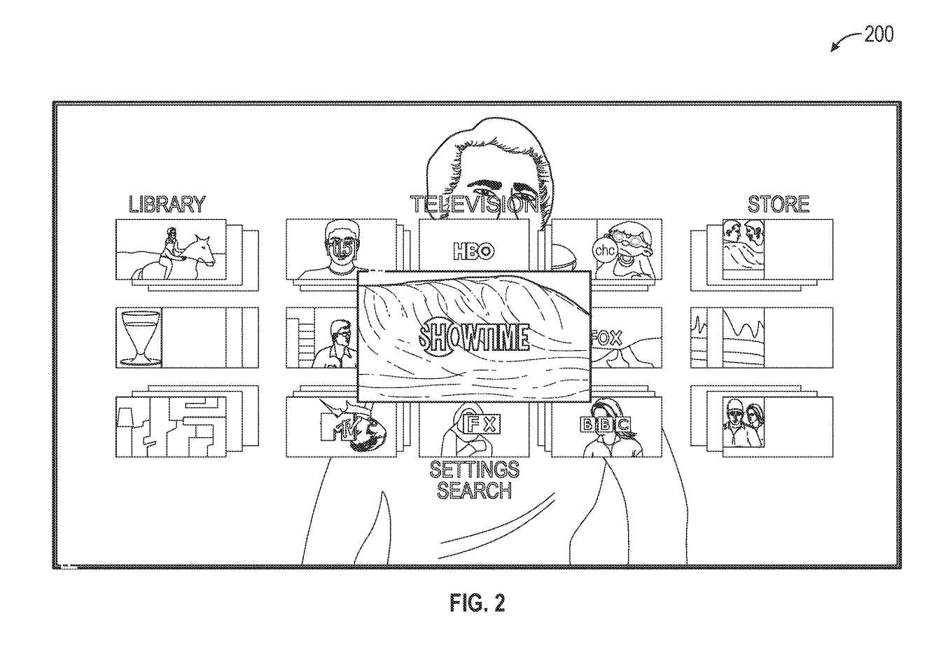

FIG. 2 shows a multi-layered image 200. As shown in FIG. 2, multi-layered image 200 may be a complicated asset and may comprise many individual layers. For example, multi-layered image 200 may comprise between 10 and 15 layers. Each of these layers may be assembled together on the cloud (e.g., on CTAP 100) and sent to a user device where the user device may render the asset. The user device may not have to assemble the layers to create multi-layered image 200. This may save CPU cycles on the user device. Moreover, once assembled on the cloud, assets such as multi-layered image 200 may be sent to multiple clients (reused) even for personalized info as this personalized is eventually personalized by “many”. In addition, dynamic on the fly decorating by UX designer may be provided by embodiments of the disclosure. This may be easily “deployed” without the need for software upgrade to all or part of the population (aka A/B testing).

Multi-layered image 200 may not just be a layered image compositor, but may also be a personalized image renderer. This may mean that a single metadata asset may include personalized information (e.g., parental control, is recorded, is purchasable, etc.) that has visual impact on multi-layered image 200. This personalized image may differ from person to person, but at the same time, may be shared across multiple people in similar states.

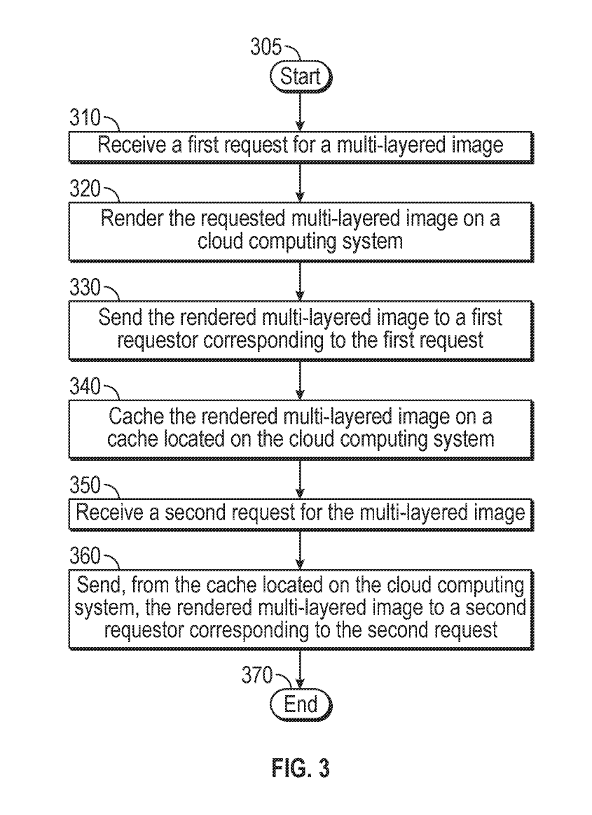

FIG. 3 is a flow chart setting forth the general stages involved in a method 300 consistent with an embodiment of the disclosure for providing cloud image rendering. Method 300 may be implemented using CTAP 100 as described in more detail above with respect to FIG. 1. Ways to implement the stages of method 300 will be described in greater detail below.

Consistent with an embodiment of the disclosure, CTAP 100 may: i) receive a request for a multi-layered image (e.g., multi-layered image 200); ii) render the requested multi-layered image on the cloud; iii) send the multi-layered image to the requestor from the cloud; and iv) cache the rendered multi-layered image on the cloud. When another request is received for the same image (i.e., multi-layered image 200), rather than recreating the same image from scratch, the requested multi-layered image may be supplied from the cache. The multi-layered image may be cashed for a predetermined time period and then deleted from the cache. If the multi-layered image contains a dynamic decorator (e.g., a progress bar), the multi-layered image may be periodically recreated (e.g., every 5 seconds) and re-cached with an updated dynamic decorator.

Method 300 may begin at starting block 305 and proceed to stage 310 where CTAP 100 may receive a first request for multi-layered image 200. For example, first thin UX application 165, running on a client device, may send the first request for multi-layered image 200 to CTAP 100 over a network, for example, the internet. Application router 120 may receive the first request and pass it on to UX engine 115.

From stage 310, where CTAP 100 receives the first request for multi-layered image 200, method 300 may advance to stage 320 where CTAP 100 may render the requested multi-layered image 200. For example, UX engine 115 may request and receive data from other elements of CTAP 100. UX engine 115 may take the requested data to assemble the layers to render multi-layered image 200.

Once CTAP 100 renders the requested multi-layered image in stage 320, method 300 may continue to stage 330 where CTAP 100 may send the rendered multi-layered image to a first requestor (e.g., first thin UX application 165) corresponding to the first request. For example, once rendered, UX engine 115 may pass multi-layered image 200 back to application router 120 that, in turn, may send multi-layered image 200 to first thin UX application 165.

After CTAP 100 sends the rendered multi-layered image 200 to the first requestor (e.g., first thin UX application 165) in stage 330, method 300 may proceed to stage 340 where CTAP 100 may cache the rendered multi-layered image 200 on a cache located on CTAP 100. For example, the cache may be located in UX engine 115 or anywhere else in CTAP 100. The rendered multi-layered image 200 may be cached on CTAP 100 for a predetermined time period and then deleted. If multi-layered image 200 contains a dynamic decorator (e.g., a progress bar), multi-layered image 200 may be periodically recreated (e.g., every 5 seconds) and re-cached with an updated dynamic decorator.

From stage 340, where CTAP 100 caches the rendered multi-layered image 200, method 300 may advance to stage 350 where CTAP 100 may receive a second request for multi-layered image 200. For example, second thin UX application 170, running on a client device, may send the second request for multi-layered image 200 to CTAP 100 over a network, for example, the internet. Application router 120 may receive the second request and pass it on to UX engine 115.

Once CTAP 100 receives the second request in stage 350, method 300 may continue to stage 360 where CTAP 100 may send, from the cache, the rendered multi-layered image 200 to a second requestor (e.g., second thin UX application 170) corresponding to the second request. For example, rather than rendering the same image twice, CTAP 100 may service the request for multi-layered image 200 from the cache. Once CTAP 100 sends the rendered multi-layered image to the second requestor (e.g., second thin UX application 170) in stage 360, method 300 may then end at stage 370.

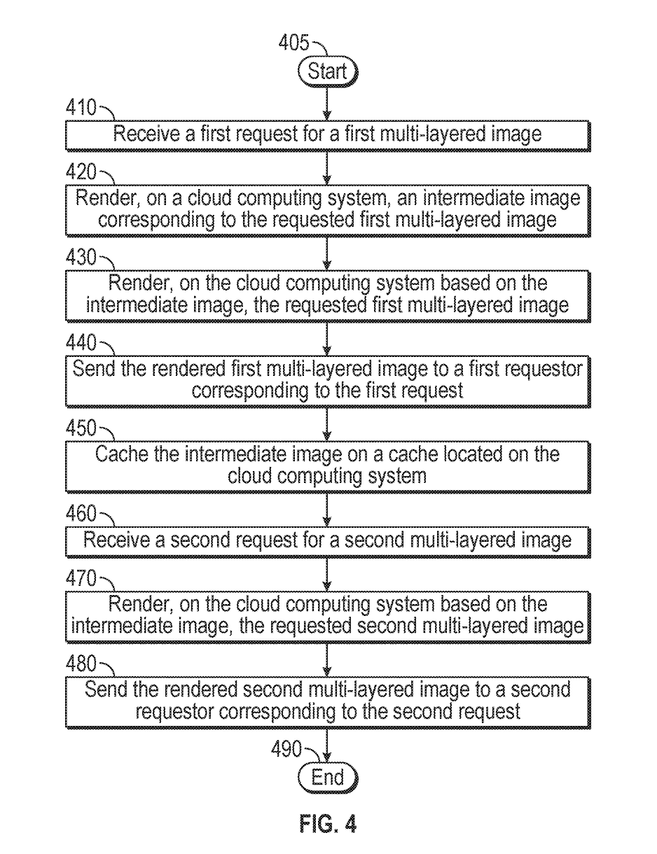

FIG. 4 is a flow chart setting forth the general stages involved in a method 400 consistent with an embodiment of the disclosure for providing cloud image rendering. Method 400 may be implemented using a CTAP 100 as described in more detail above with respect to FIG. 1. Ways to implement the stages of method 400 will be described in greater detail below.

Consistent with another embodiment of the disclosure, CTAP 100 may reuse a partially complete multi-layered image. For example, a request may be received for a first multi-layered image (e.g., multi-layered image 200) comprising a first plurality of layers and a second plurality of layers. An intermediate image may be created comprising the first plurality of layers. The intermediate image may be cached on CTAP 100. Then, when a request is received by CTAP 100 for a second multi-layered image that may include the first plurality of layers, the cached intermediate image may be used to create the second multi-layered image without having to re-assemble the first plurality of layers. Rather additional layers (e.g., a third plurality of layers) may be added to the intermediate image to render the second multi-layered image. Examples for the first plurality of layers for the intermediate image may comprise, but are not limited to, a base image, an asset name, start/end time, description, different image sizes (per screen, device type), and price. Examples for the second plurality of layers or third plurality of layers that may be added to the intermediate image may comprise, but are not limited to, is recorded, is purchasable, is locked, is playable, is recommended, and advertisements.

For example, the first multi-layered image and the second multi-layered image may be identical to one another except for a time layer and a language layer. A first request may be received, a first time layer and a first language layer may be added to the intermediate image, and this first request may be fulfilled. Then, a second request may be received, a second time layer and a second language layer may be added to the intermediate image, and this second request may be fulfilled. The intermediate image may be cashed for a predetermined time period and then deleted from the cache. If the intermediate image contains a dynamic decorator (e.g., a progress bar), the intermediate image may be periodically recreated (e.g., every 5 seconds) and re-cached with an updated dynamic decorator.

Method 400 may begin at starting block 405 and proceed to stage 410 where CTAP 100 may receive a first request for a first multi-layered image (e.g., multi-layered image 200). For example, first thin UX application 165, running on a client device, may send the first request for the first multi-layered image to CTAP 100 over a network, for example, the internet. Application router 120 may receive the first request and pass it on to UX engine 115.

From stage 410, where CTAP 100 receives the first request for the first multi-layered image, method 400 may advance to stage 420 where CTAP 100 may render an intermediate image corresponding to the requested first multi-layered image. For example, UX engine 115 may request and receive data from other elements of CTAP 100. UX engine 115 may take the requested data to assemble the layers to render the intermediate image. The intermediate image may comprise some, but not all of the layers of the first multi-layered image. In other words, the intermediate image may have fewer layers than the first multi-layered image.

Once CTAP 100 renders the intermediate image in stage 420, method 400 may continue to stage 430 where CTAP 100 may render, based on the intermediate image, the requested first multi-layered image. For example, the intermediate image may comprise some, but not all, of the layers of the first multi-layered image. UX engine 115 may request and receive data for the remaining layer or layers of the first multi-layered image from other elements of CTAP 100. UX engine 115 may then take the requested data for the remaining layer or layers and add them to the intermediate image to assemble and render the requested first multi-layered image.

After CTAP 100 renders, based on the intermediate image, the requested first multi-layered image in stage 430, method 400 may proceed to stage 440 where CTAP 100 may send the rendered first multi-layered image to a first requestor (e.g., first thin UX application 165) corresponding to the first request. For example, once rendered, UX engine 115 may pass the first multi-layered image back to application router 120 that, in turn, may send the first multi-layered image to first thin UX application 165.

From stage 440, where CTAP 100 sends the rendered first multi-layered image to the first requestor, method 400 may advance to stage 450 where CTAP 100 may cache the intermediate image on a cache located on a cache located on CTAP 100. For example, the cache may be located in UX engine 115 or anywhere else in CTAP 100. The rendered intermediate image may be cached on CTAP 100 for a predetermined time period and then deleted. If the intermediate image contains a dynamic decorator (e.g., a progress bar), the intermediate image may be periodically recreated (e.g., every 5 seconds) and re-cached with an updated dynamic decorator.

Once CTAP 100 caches the intermediate image in stage 450, method 400 may continue to stage 460 where CTAP 100 may receive a second request for a second multi-layered image. For example, second thin UX application 170, running on a client device, may send the second request for the second multi-layered image to CTAP 100 over a network, for example, the internet. Application router 120 may receive the second request and pass it on to UX engine 115.

After CTAP 100 receives the second request for a second multi-layered image in stage 460, method 400 may proceed to stage 470 where CTAP 100 may render, based on the intermediate image, the requested second multi-layered image. For example, the intermediate image may comprise some, but not all of the layers of the second multi-layered image. UX engine 115 may request and receive data for the remaining layer or layers of the second multi-layered image from other elements of CTAP 100. UX engine 115 may then take the requested data for the remaining layer or layers and add them to the intermediate image to assemble and render the requested second multi-layered image. In other words, rather than building the second multi-layered image from scratch, the intermediate image may be obtained from the cache and the second multi-layered image may be built based on the intermediate image.

From stage 470, where CTAP 100 renders, based on the intermediate image, the requested second multi-layered image, method 400 may advance to stage 480 where CTAP 100 may send the rendered second multi-layered image to a second requestor (e.g., second thin UX application 170) corresponding to the second request. Once CTAP 100 sends the rendered second multi-layered image to the second requestor in stage 480, method 400 may then end at stage 490.

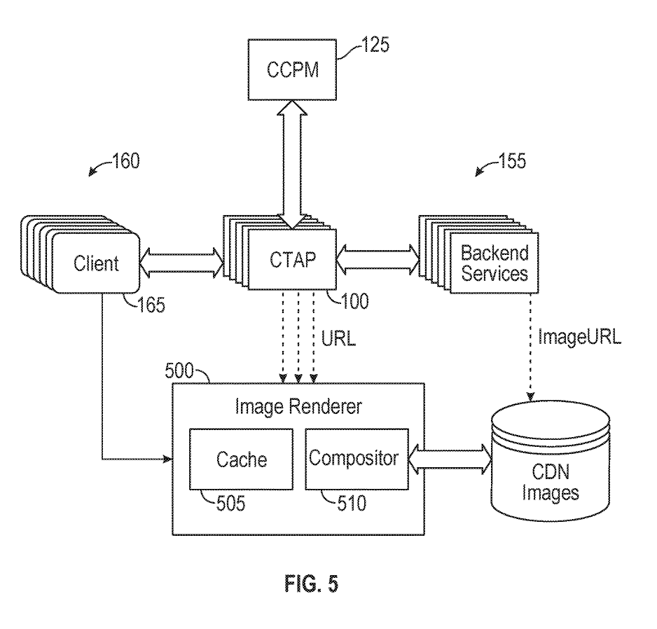

FIG. 5 shows CTAP 100 as well as other systems similar to CTAP 100 utilizing a separate image renderer 500. As shown in FIG. 5, image renderer 500 may comprise a cache 505 and a compositor 510. Consistent with embodiments of the disclosure, any one or more of the stages from method 300 or method 400 described above with respect to FIG. 3 and FIG. 4 may be carried out by image renderer 500. For example, the rendering functionality may be carried out by compositor 510 of image renderer 500 and the caching functionality may be carried out by cache 505 of image renderer 500. CTAP 100 may supply a URL of a rendered image to one of the plurality of thin UX applications 160 that may use the URL to obtain the rendered image from image render 500. Any number of CTAP systems may be similar to CTAP 100 and may utilize image render 500 in the same way that CTAP 100 utilizes image render 500.

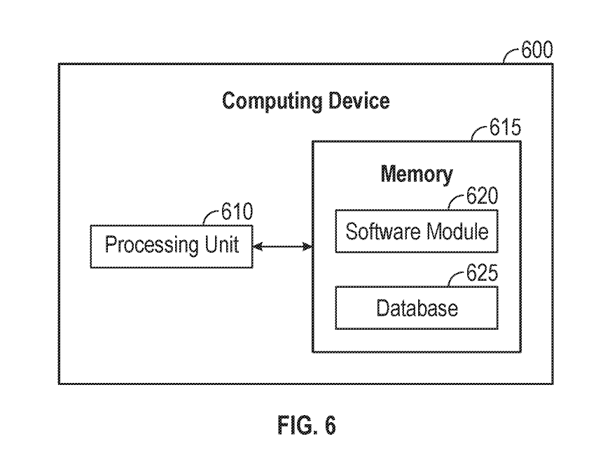

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform processes for providing cloud image rendering, including for example, any one or more of the stages from method 300 or method 400 described above with respect to FIG. 3 and FIG. 4. Computing device 600, for example, may provide an operating environment for image render 500 as well as elements of CTAP 100 including, but not limited to, plurality of pluggable backend connectors (PBCs) 105, metadata engine 110, user experience (UX) engine 115, application router 120, and client cloud package manager (CCPM) 125. Image render 500 and elements of CTAP 100 may operate in other environments and are not limited to computing device 600.

Computing device 600 may be implemented using a personal computer, a network computer, a mainframe, a router, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-Only Memory (ROM), an Erasable Programmable Read-Only Memory (EPROM or Flash memory), an optical fiber, and a portable Compact Disc Read-Only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure may be practiced via a System-On-a-Chip (SOC) where each or many of the components illustrated in FIG. 2 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a first request for a multi-layered image;
rendering the requested multi-layered image on a cloud computing system;
sending the rendered multi-layered image to a first requestor corresponding to the first request;
caching the rendered multi-layered image on a cache located on the cloud computing system;
receiving a second request for the multi-layered image; and
sending, from the cache located on the cloud computing system, the rendered multi-layered image to a second requestor corresponding to the second request.

2. The method of claim 1, wherein receiving the first request for the multi-layered image comprises receiving the first request for the multi-layered image comprising between 10 and 15 layers.

3. The method of claim 1, wherein sending the rendered multi-layered image to the first requestor comprises sending the rendered multi-layered image to the first requestor comprising a thin user experience application.

4. The method of claim 1, wherein sending the rendered multi-layered image to the first requestor comprises sending the rendered multi-layered image to the first requestor comprising a thin user experience application resident on a user device comprising one of the following: a tablet device; a smart phone; a computer; and a television.

5. The method of claim 1, wherein caching the rendered multi-layered image on the cache located on the cloud computing system comprises caching the rendered multi-layered image on the cache located on the cloud computing system comprising a cloud television application platform (CTAP).

6. The method of claim 1, wherein caching the rendered multi-layered image on the cache located on the cloud computing system comprises caching the rendered multi-layered image on the cache located on the cloud computing system for a predetermined time period.

7. The method of claim 1, further comprising:
determining that the multi-layered image contains a dynamic decorator;
recreating the multi-layered image in response to determining that the multi-layered image contains the dynamic decorator; and
re-caching the recreated multi-layered image.

8. The method of claim 1, further comprising:
determining that the multi-layered image contains a dynamic decorator comprising a progress bar;
recreating the multi-layered image with an updated progress bar in response to determining that the multi-layered image contains the dynamic decorator; and
re-caching the recreated multi-layered image containing the updated progress bar.

9. A method comprising:
receiving a first request for a first multi-layered image;
rendering, on a cloud computing system, an intermediate image corresponding to the requested first multi-layered image;
rendering, on the cloud computing system based on the intermediate image, the requested first multi-layered image;
sending the rendered first multi-layered image to a first requestor corresponding to the first request;
caching the intermediate image on a cache located on the cloud computing system;
receiving a second request for a second multi-layered image;
rendering, on the cloud computing system based on the intermediate image, the requested second multi-layered image; and
sending the rendered second multi-layered image to a second requestor corresponding to the second request.

10. The method of claim 9, wherein rendering the intermediate image corresponding to the requested first multi-layered image comprises rendering the intermediate image wherein the intermediate image has less layers than the first multi-layered image.

11. The method of claim 9, wherein sending the rendered first multi-layered image to the first requestor comprises sending the rendered first multi-layered image to the first requestor comprising a thin user experience application.

12. The method of claim 9, wherein sending the rendered first multi-layered image to the first requestor comprises sending the rendered first multi-layered image to the first requestor comprising a thin user experience application resident on a user device.

13. The method of claim 9, wherein caching the rendered intermediate image on the cache located on the cloud computing system comprises caching the rendered intermediate image on the cache located on the cloud computing system for a predetermined time period.

14. The method of claim 9, further comprising:
determining that the intermediate image contains a dynamic decorator;
recreating the intermediate image in response to determining that the intermediate image contains the dynamic decorator; and
re-caching the recreated intermediate image.

15. The method of claim 9, further comprising:
determining that the intermediate image contains a dynamic decorator comprising a progress bar;
recreating the intermediate image with an updated progress bar in response to determining that the intermediate image contains the dynamic decorator; and
re-caching the recreated intermediate image containing the updated progress bar.

16. A system comprising:
a user device comprising a thin user experience application resident on the user device; and
a cloud television application platform (CTAP) configured to;
receive a first request for a multi-layered image from the thin user experience application,
render the requested multi-layered image,
send the rendered multi-layered image to the thin user experience application,
cache the rendered multi-layered image on a cache located on the CTAP,
receive a second request for the multi-layered image, and
send, from the cache located on the CTAP, the rendered multi-layered image to a second requestor corresponding to the second request.

17. The system of claim 16, the user device comprises one of the following: a tablet device; a smart phone; a computer; and a television.

18. The system of claim 16, wherein the CTAP being configured to cache the rendered multi-layered image comprises the CTAP being configured to cache the rendered multi-layered image for a predetermined time period.

19. The system of claim 16, wherein the CTAP is further configured to:
determine that the multi-layered image contains a dynamic decorator;
recreate the multi-layered image in response to determining that the multi-layered image contains the dynamic decorator; and
re-cache the recreated multi-layered image.

20. The system of claim 16, wherein the CTAP is further configured to:
determine that the multi-layered image contains a dynamic decorator comprising a progress bar;
recreate the multi-layered image with an updated progress bar in response to determining that the multi-layered image contains the dynamic decorator; and
re-cache the recreated multi-layered image containing the updated progress bar.
